(19) United States
(12) Patent Application Publication
(10) Pub. No.: US 2008/0307624 A1
(43) Pub. Date: Dec. 18, 2008

(54) RIVETING STRUCTURE

(76) Inventor: Hsiao-Lung Lee, Hsin Tien City (TW)

Correspondence Address: SINORICA, LLC, 528 FALLSGROVE DRIVE, ROCKVILLE, MD, 20850, US

(21) Appl. No.: 11/761,392

(22) Filed: Jun. 12, 2007

(51) Int. Cl. B23P 11/00

(52) U.S. Cl. 29/243.54; 29/524.1; 29/509

(57) ABSTRACT

A riveting structure comprises a connector and a metal plate. The proposed riveting structure differs from the prior art in that the connector has an even number of parallel positioning sides and the shape of an opening on the metal plate corresponds to that of a connection member on the connector so that the connector can be positioned in the opening. Moreover, the width of parallel sides of the opening can be properly adjusted to meet the requirement of various different torques.

### BACKGROUND OF THE INVENTION

1. Field of the Invention

The present invention relates to a riveting structure and, more particularly, to a riveting structure which improves the manner of positioning a conventional connector and a metal plate.

2. Description of Related Art

As shown in FIG. 1, a prior art riveting structure 12 comprises a connector 14 and a metal plate 16. A circular hole shaped connection member 142 is disposed on the connector 14. A central needle 18 located at the center of the connection member 142 is also provided. A circular opening 162 corresponding to the connection member 142 is provided on the metal plate 16. The shape of the opening 162 corresponds to that of the connection member 142. FIG. 2 shows the situation after the connector 14 and the metal plate 16 are riveted together. The above riveting technique used by a riveting machine makes use of fixed point riveting. Four positioning raised points 164 on the opening 162 are used to prevent the connector 14 from rotating. The material of the connector 14 protruding out of the metal plate 16 is pressed inside out by means of punch riveting to tightly fit with the metal plate 16 so that the opening 162 can tightly match the connection member 142.

However, the riveting method used by existent riveting machines has the disadvantage that the torque and tension between the connector 14 and the metal plate 16 are hard to standardize and guarantee after the connector 14 is riveted. If the torque or tension is too large or too small, the connector 14 and the metal plate 16 will easily deform or cannot be tightly fitted together.

Accordingly, the present invention aims to propose a riveting structure to improve the above drawback in the prior art.

### SUMMARY OF THE INVENTION

A primary object of the present invention is to provide a riveting structure, which makes use of a novel connector and a novel metal plate to more conveniently and precisely position the connector on the metal plate.

Another object of the present invention is to provide a riveting structure, which can adjust the width of parallel sides of an opening of the metal plate to meet the requirement of various different torques.

To achieve the above objects, the present invention provides a riveting structure comprises a connector and a metal plate. The connector has two parallel positioning sides. The shape of an opening on the metal plate corresponds to that of the connector so that the connector can be positioned in the opening. The connector and metal plate provided by the present invention can more conveniently and precisely position the connector on the metal plate. Moreover, the width of parallel sides of the opening on the metal plate can be properly adjusted to meet the requirement of various different torques.

### BRIEF DESCRIPTION OF THE DRAWINGS

The various objects and advantages of the present invention will be more readily understood from the following detailed description when read in conjunction with the appended drawing, in which:

FIG. 1 is a diagram of the prior art riveting structure before implementation;

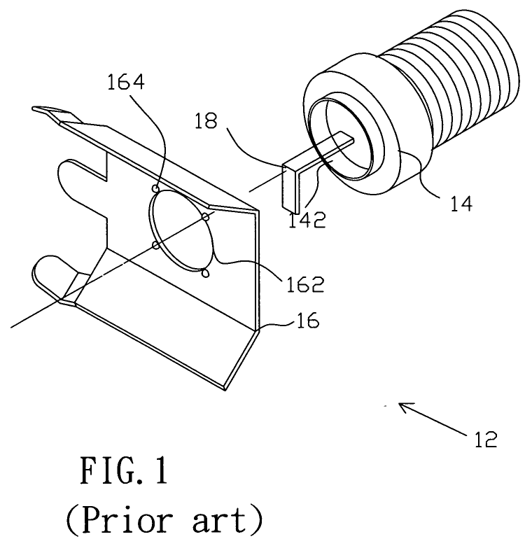

FIG. 2 is a diagram of the prior art riveting structure after implementation;

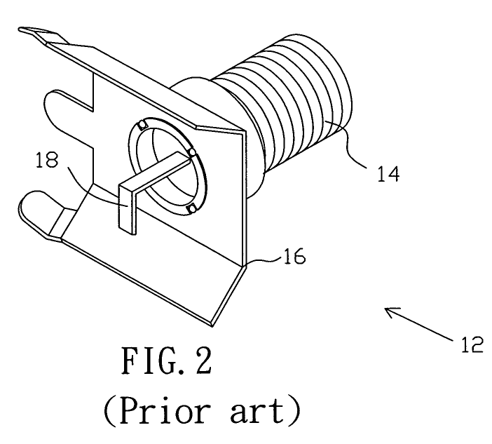

FIG. 3 is a diagram of the riveting structure of the present invention before implementation; and

FIG. 4 is a diagram of the riveting structure of the present invention after implementation.

### DETAILED DESCRIPTION OF THE PREFERRED EMBODIMENTS

In the industry or the decoration industry, riveting machines are primarily used as special manual tools for assembly between metal plates. For example, for lapping between metal plates, a rivet is used to penetrate two metal plates, and a coned punch on a riveting machine is utilized to clamp the rivet. When a user presses down a push handle, the riveting machine will retreat to lead the coned punch to move backwards, and the tube of the rivet will deform and crumple, hence finishing the lapping between metal plates. Therefore, the lapping between metal plates is completed by pulling the coned punch backwards. How to precisely control the deformation and crumple and positioning during riveting is a very important topic in the riveting technology. The present invention thus provides a riveting structure having a novel rivet to improve the positioning manner in the prior art.

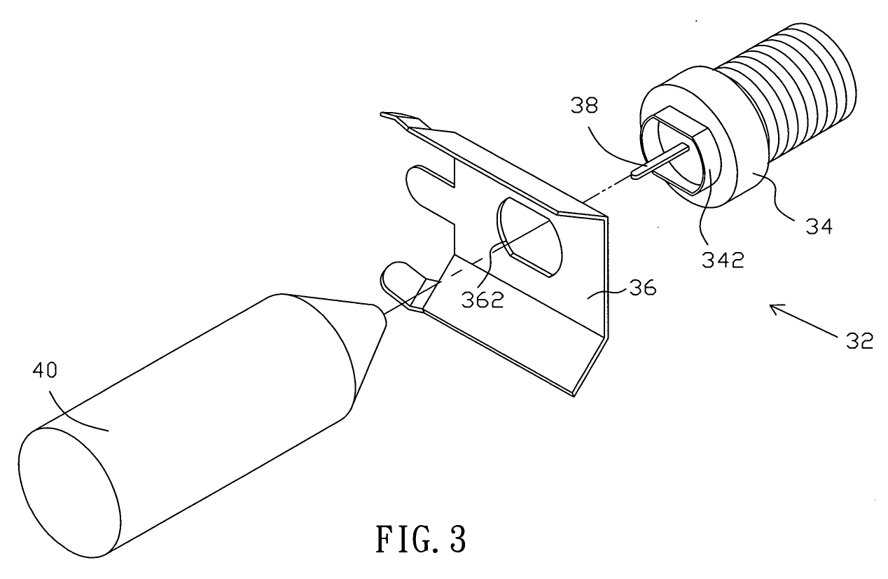

As shown in FIG. 3, the present invention provides a riveting structure 32, which comprises a connector 34 and a metal plate 36. The connector 34 has a central needle 38. Different from the prior art, the shape of a connection member 342 on the connector 34 is a circular hole having two parallel positioning sides. The connection member 342 can also be of any shape. Symmetric shapes such as those having four parallel positioning sides are preferred.

The shape of an opening 362 on the metal plate 36 corresponds to that of the connection member 342, and the connector 34 can be positioned in the opening 362. The connector 34 and the metal plate 36 provided by the present invention can allow the connector 34 be more conveniently and precisely positioned on the metal plate 36. Moreover, the width of parallel sides of the opening 362 can be properly adjusted to meet the requirement of various different torques. The longer the two parallel positioning sides of the connection member 342, the larger torque the metal plate 36 can bear.

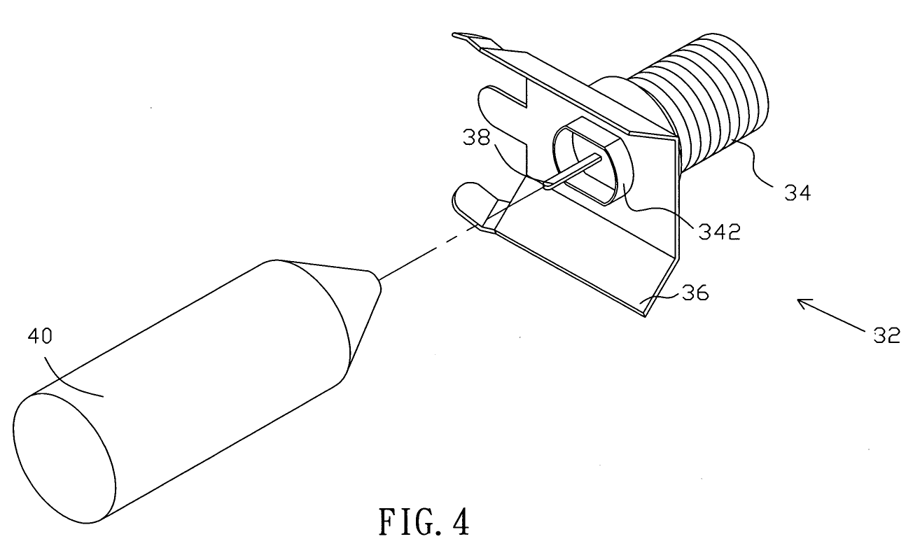

After the connector 34 is installed in the metal plate 36 along the correct direction, a coned punch 40 on a riveting machine is used to extrude the connection member 342 to let the connection member 342 expand outwards and deform and then tightly press the metal plate 36, thereby tightly joining the connector 34 and the metal plate 36. The situation after the connector 34 and the metal plate 36 are tightly joined is shown in FIG. 4. The above riveting machine can be a pneumatic and hydraulic riveting machine, a pneumatic riveting machine, a hydraulic riveting machine, or an electrical riveting machine.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

### REFERENCE NUMERALS

12: riveting structure
14: connector
142: connection member
16: metal plate
162: opening
164: raised point
18: central needle
32: riveting structure
34: connector
342: connection member
36: metal plate
362: opening
38: central needle
40: coned punch

I claim:

1. A riveting structure comprising:
a connector having an even number of parallel positioning sides; and
a metal plate having an opening, shape of said opening corresponding to a connection member on said connector is positioned in said opening.

2. The riveting structure as claimed in claim 1, wherein after said connection member on said connector penetrates said metal plate, a coned punch on a riveting machine is used to extrude said connection member to allow said connection member to expand outwards and tightly press said metal plate, thereby tightly joining said connector and said metal plate.

3. The riveting structure as claimed in claim 2, wherein said riveting machine is a pneumatic and hydraulic riveting machine, a pneumatic riveting machine, a hydraulic riveting machine, or an electrical riveting machine.

4. The riveting structure as claimed in claim 1, wherein said opening has two parallel positioning sides that correspond to said connector, and longer said two parallel sides, larger torque said metal plate is bear.
